(19) United States
(12) Patent Application Publication
(10) Pub. No.: US 2025/0029342 A1
(43) Pub. Date: Jan. 23, 2025

(54) METHOD FOR EFFECT PROCESSING, DEVICE, AND STORAGE MEDIUM

(71) Applicant: BEIJING ZITIAO NETWORK TECHNOLOGY CO., LTD., Beijing (CN)

(72) Inventor: Qi DONG, Beijing (CN)

(21) Appl. No.: 18/777,734

(22) Filed: Jul. 19, 2024

(30) Foreign Application Priority Data
Jul. 21, 2023 (CN) 202310907962.4

(51) Int. Cl. G06T 19/00; G06T 5/50; G06T 5/77; G06T 19/20; G06V 10/46

(52) U.S. Cl. CPC G06T 19/006; G06T 5/50; G06T 5/77; G06T 19/20; G06V 10/46; G06T 2207/20221; G06T 2219/2012; G06T 2219/2021

(57) ABSTRACT

A method for effect processing, a device, and a storage medium are provided. The method includes: in response to a wear trigger operation on an effect wearable item, performing model blocking processing on an effect three-dimensional model of the effect wearable item to obtain an effect blocking three-dimensional model; acquiring a target object original image currently displayed comprising a target object, and determining an object contour image of the target object original image, where a wear body of the effect wearable item is located on the target object; and based on the effect blocking three-dimensional model in combination with the object contour image, determining and displaying an effect combined image.

### CROSS-REFERENCE TO RELATED APPLICATION

This application claims the priority to and benefits of the Chinese Patent Application No. 202310907962.4, which was filed on Jul. 21, 2023, and is hereby incorporated by reference in its entirety.

### TECHNICAL FIELD

Embodiments of the present disclosure relate to the field of the image processing technology, and in particular, to a method for effect processing, a device, and a storage medium.

### BACKGROUND

With the development of the network technology, the augmented reality AR technology is increasingly used in live streaming, short video interactive entertainment, and other entertainment application software, and visual effect of participants in a live streaming interface, a short video interface, or even an interactive entertainment interface can be enhanced through provided AR effect props.

In an effect application, an effect wearable item is also one of AR effect props, where a selected effect wearable item (for example, a hat, a necklace, or a watch) may be presented on a part on which the participant expects to wear the effect wearable item. In an effect processing implementation of the effect wearable item, an effect model of the effect wearable item is usually rendered on the wear part of a participating object, to combine a picture of the effect wearable item and a picture of the wear part, thereby forming an effect combined picture.

However, in the effect combined picture presented in the foregoing rendering manner, there are problems that the effect wearable item is not closely attached to the wear part, edges link up unnaturally, and sense of reality is poor. This reduces use experience of the participant for the augmented reality effect prop.

### SUMMARY

At least one embodiment of the present disclosure provides a method and apparatus for effect processing, a device, and a storage medium.

At least one embodiment of the present disclosure provides a method for effect processing, which includes:
in response to a wear trigger operation on an effect wearable item, performing model blocking processing on an effect three-dimensional model of the effect wearable item to obtain an effect blocking three-dimensional model;
acquiring a target object original image currently displayed including a target object, and determining an object contour image of the target object original image, where a wear body of the effect wearable item is located on the target object; and
based on the effect blocking three-dimensional model in combination with the object contour image, determining and displaying an effect combined image.

At least one embodiment of the present disclosure further provides an apparatus for effect processing, which includes:
an operation response module configured to, in response to a wear trigger operation on an effect wearable item, perform model blocking processing on an effect three-dimensional model of the effect wearable item to obtain an effect blocking three-dimensional model;
a contour image determining module configured to acquire a target object original image currently displayed including a target object, and determine an object contour image of the target object original image, where the wear body of the effect wearable item is located on the target object; and
an image display module configured to determine and display an effect combined image based on the effect blocking three-dimensional model in combination with the object contour image.

At least one embodiment of the present disclosure provides an electronic device, which includes:
one or more processors; and
at least one memory, configured to store one or more programs,
when the one or more programs are executed by the one or more processors, causing the one or more processors to implement the method for effect processing according to at least one embodiment of the present disclosure.

At least one embodiment of the present disclosure provides a non-transient computer-readable storage medium, which includes computer-executable instructions, the computer-executable instructions when executed by a processor of a computer, implement the method for effect processing according to at least one embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic diagram of an effect wearable item in a presentation form for wearable presentation;

FIG. 2 is a flowchart of a method for effect processing according to an embodiment of the present disclosure;

FIG. 3 is a schematic diagram of an object contour image during execution of a method for effect processing according to an embodiment of the present disclosure;

FIG. 4 is a schematic diagram of presentation of an effect wearable item after processing is performed by using a method for effect processing according to an embodiment of the present disclosure;

FIG. 5 is a schematic diagram of an effect processing intermediate image during execution of a method for effect processing according to an embodiment of the present disclosure;

FIG. 6 is a schematic diagram of a first effect processing image during execution of a method for effect processing according to an embodiment of the present disclosure;

FIG. 7 is a principle diagram of an erosion algorithm during execution of a method for effect processing according to an embodiment of the present disclosure;

FIG. 8 is a schematic structural diagram of an apparatus for effect processing according to an embodiment of the present disclosure; and

FIG. 9 is a schematic structural diagram of an electronic device according to an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of the messages or information interacted with between the plurality of apparatuses of the embodiments of the present disclosure are used for illustrative purposes only and are not intended to place limitations on the scope of those messages or information.

It may be understood that before the technical solutions disclosed in embodiments of the present disclosure are used, the user should be informed of the type of personal information involved in the present disclosure, the scope of use, use scenarios, and the like in a proper manner in accordance with the relevant laws and regulations, and authorization of the user should be obtained.

For example, prompt information is sent to a user in response to receiving an active request of the user, to explicitly prompt the user that an operation that the user requests to execute needs to obtain and use personal information of the user. In this way, the user can actively select, based on the prompt information, whether to provide the personal information to software or hardware such as an electronic device, an application, a server, or a storage medium that performs the operation of the technical solution of the present disclosure.

In an optional but non-restrictive implementation, a manner of sending the prompt information to the user in response to receiving the active request of the user may be, for example, a pop-up manner, and the prompt information may be presented in a text manner in a pop-up window. In addition, the pop-up window may further carry a selection control for the user to select “agree” or “disagree” to provide the personal information to the electronic device.

It may be understood that the foregoing notification and user authorization obtaining process is only schematic and does not constitute a limitation on the implementation of present disclosure, and other manners that meet relevant laws and regulations may also be applied in the implementation of the present disclosure.

It is known that that effect props have been common functions in live streaming, short video, and other interactive entertainment applications, and the effect of live streaming or short videos can be better enhanced through the use of the effect props. As one of the effect props, an effect wearable item can be presented at an associated wear display position after a user triggers an effect wear function.

For example, after the user selects an effect hat as the effect wearable item and triggers a wear operation of the effect hat, the effect hat may be presented at a position of the user's head in a picture displaying the user. FIG. 1 is a schematic diagram of an effect wearable item in a presentation form for wearable presentation. FIG. 1 shows an effect combined image 11 obtained by processing a participant and an effect hat, and based on a region 111 in which the effect hat and hair link up in the effect combined image 11, it can be seen that a part that is of a back edge of the effect hat and that should have been blocked by the hair is exposed to be shown and the hair that blocks the part of the back edge of the hat and that should have been displayed is blocked by the part of the back edge of the effect hat and is not shown. It can be learned, based on FIG. 1, that there are problems with the effect processing manner, that is, in the effect processing manner, there will be problems that the effect wearable item is not closely attached to the wear part, edges link up unnaturally, and sense of reality is poor. This reduces use experience of the participant for the augmented reality effect prop.

In addition, after wearing the effect wearable item, a participant may want to adjust an orientation posture to see the effect of wearing the effect wearable item when the participant is in different orientation postures. In an implementation, even if the effect wearable item can effectively block an object to be blocked when the participant is in a frontal orientation, with the adjustment of the posture of the participant, the presentation position of the effect wearable item will also change, and there will also be problems that that the effect wearable item is not closely attached to the wear part, edges link up unnaturally, and sense of reality is poor. This reduces use experience of the participant for the augmented reality effect prop.

Based on this, this embodiment provides a method for effect processing. In the method, when an effect wearable item is worn on a target object, content that should not be displayed can be blocked, so as to make the effect wearable item closely attached to the wear part, and to make the edges link up naturally, so as to enhance the wear effect of the effect wearable item.

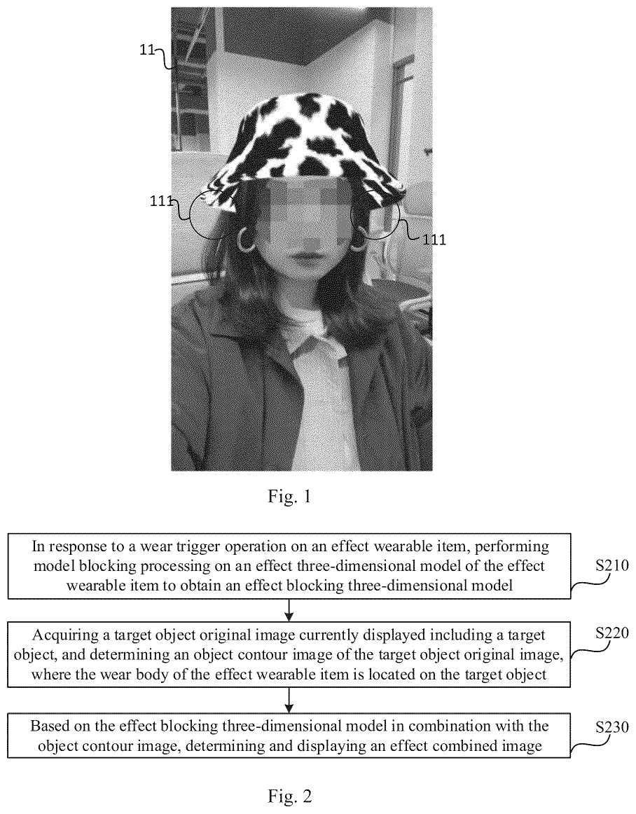

Specifically, FIG. 2 is a flowchart of a method for effect processing according to an embodiment of the present disclosure. The embodiment of the present disclosure is applicable to a case of processing effect of an effect wearable item and a wear part. The method may be performed by an apparatus for effect processing. The apparatus may be implemented in a form of software and/or hardware. Optionally, this may be implemented by an electronic device as an execution terminal. The electronic device may be mobile terminal, a PC terminal, a server, or the like.

As shown in FIG. 2, a method for effect processing according to an embodiment of the present disclosure specifically includes the following operations.

S210, in response to a wear trigger operation on an effect wearable item, performing model blocking processing on an effect three-dimensional model of the effect wearable item to obtain an effect blocking three-dimensional model.

In this embodiment, the effect wearable item may be regarded as an AR effect prop that can play the role of augmented reality, and may be an effect hat, an effect accessory (such as an effect necklace, an effect watch, or effect glasses), an effect outfit, or the like, and may be regarded as a prop product that can be worn on a particular part of a participant's body. Generally, different types of effect wearable items may be provided in an application scenario for selection by a participant, and similarly, different effect wearable items may also be present in different effect application scenarios.

It may be understood that it may be considered that conventional preview display of a target object may be performed before a wear trigger operation is performed on the effect wearable item in the application scenario. To be specific, it may be considered that a running relevant interactive entertainment application (for example, live streaming or a short video) presents a normal preview picture of the target object in a normal state.

In this embodiment, when the participant wants to wear the effect wearable item, the effect wearable item may be selected and triggered. This step may respond to the wear trigger operation generated by selecting the effect wearable item. In one of the manners of generating the wear trigger operation, the participant or an interaction support person selects any effect wearable item in an effect wearable item display region, and selects and triggers the effect wearable item.

For example, an example in which the participant wears an effect hat is used for description. Assuming that the participant wants to wear the effect hat, the effect hat may be selected in the effect wearable item display region, and the effect hat is selected and triggered. After a wear operation is performed on the effect hat, the effect hat may be presented at the head position of the participant in a picture displaying the participant. It is considered that after an effect processing is used, the effect hat and hair that is located at the head position link up unnaturally and unrealistically, a back edge that is of the hat and that should have been blocked by the hair is exposed to be displayed, and hair that should have been displayed is blocked by the back edge of the hat and is not displayed.

The effect to be achieved in this embodiment may be described as follows: in the method for effect processing provided in this embodiment, when the participant wears the effect wearable item, the wearable item can be presented more realistically and naturally, and the effect wearable item and the participant link up more naturally, so as to improve the wear effect of the effect wearable item. To achieve this objective, a fusion rendering process between the effect wearable item and the participant needs to be focused.

It may be understood that the effect wearable item is actually obtained by rendering an underlying effect three-dimensional model. If fusion between the effect wearable item and a wear part of the participant is carried out by rendering the effect three-dimensional model directly to the wear part, the picture obtained through fusion is not real. Therefore, in this embodiment, in response to the wear trigger operation on the effect wearable item, processing is first performed based on the obtained effect three-dimensional model of the effect wearable item as a basic step for fusing the effect wearable item with the target object.

It is considered that, when an effect processing manner is used for fusion between the effect wearable item and the target object, a back part that is of the effect wearable item and that should have been blocked by the target object is exposed to be displayed, and a part that is of the target object and that should have been displayed is blocked by the back part of the effect wearable item and is not displayed. Therefore, in this step, the effect three-dimensional model of the effect wearable item is blocked, and a new model is obtained after the effect three-dimensional model is blocked, and the new model is denoted as the effect blocking three-dimensional model in this embodiment.

Following on from the foregoing description, to block the effect three-dimensional model, a blocking plane and a position at which the blocking plane should be placed need to be first determined. For example, a specific implementation of the blocking plane may be as follows: determining bottom vertexes of the effect three-dimensional model based on model vertex information of the effect three-dimensional model; determining a bottom plane based on the bottom vertexes, where the bottom plane includes a maximum plane length value and a central axis; determining a height value of the blocking plane based on the target object; determining the blocking plane based on the maximum plane length value and the height value; placing the blocking plane at the central axis; and forming the effect blocking three-dimensional model based on the effect three-dimensional model and the blocking plane.

For example, an example in which the effect wearable item is an effect hat is used for description. The effect hat in three-dimensional space is a three-dimensional model of the hat. In this case, a blocking plane is found for the three-dimensional model of the hat, and the blocking plane is horizontally placed at a central part of the hat. The placement of the blocking plane is equivalent to a combination of the blocking plane and the original three-dimensional model of the hat, and after blocking processing is performed, the effect blocking three-dimensional model is formed.

It is to be made clear that model blocking processing is performed on the effect three-dimensional model of the effect wearable item for the following purpose: when the effect blocking three-dimensional model obtained through processing is to be rendered, a front part of the effect wearable item is presented without blocking during actual presentation. There is actually a blocking relationship between the back part of the effect wearable item and the target object. If the effect three-dimensional model is directly rendered to the wear part on the target object, good presentation effect cannot be achieved. In this embodiment, the blocking plane is disposed, so that only the front part of the effect three-dimensional model is presented during rendering, and the back part of the effect three-dimensional model is first blocked as an interfering part, and then filling is implemented based on subsequent processing.

For example, the effect hat is used as an example for description. After the effect hat is worn to the head position of the target object, actual presentation effect is that the back edge part of the effect hat is blocked by the hair of the target object, and in terms of the presentation effect, front pictures of a front edge of the hat and the hair should be seen, and the hair blocks the back edge of the hat, or it may also be understood that the hair should be located inside the back edge of the hat. Considering that there is a blocking relationship between the back edge of the effect hat and the hair, and this effect cannot be well achieved through direct rendering, a blocking plane is disposed. The blocking plane enables only the part of the front edge of the hat to be seen during subsequent rendering. The back interfering part is first blocked, and this part is filled based on subsequent processing. In this embodiment, this blocking plane can block the back edge part of the effect hat, and in terms of effect presentation, only the hair can be seen, and the hair is located inside the back edge of the effect hat.

Generally, after entering a wear scenario of the effect wearable item to present an effect combined picture, a target object rarely remains still. In a normal case, after participating in the wear scenario of the effect wearable item, the target object may perform some actions (such as twisting the head, rotating the neck, turning sideways, or turning over the palm of the hand) to view the wear effect of the effect wearable item. The action performed by the target object is equivalent to posture adjustment, and a presentation state of the effect wearable item usually changes with a posture change of the target object. In this embodiment, model blocking processing is performed on the effect three-dimensional model of the effect wearable item, to obtain the effect blocking three-dimensional model. Regardless of how the posture is adjusted, the two-dimensional blocking plane is also adjusted with the posture, so as to ensure that the back part of the effect three-dimensional model can be blocked under any posture.

S220, acquiring a target object original image currently displayed including a target object, and determining an object contour image of the target object original image, where the wear body of the effect wearable item is located on the target object.

In this embodiment, the target object may be specifically regarded as a subject participating in effect processing, and may be an entity having a movement capability, such as a person, an animal, or the like. For example, the target object may serve as a participant in application scenarios such as live streaming, short videos, and human-computer interaction, and may be specifically presented in a live streaming picture, a short video picture, or another human-computer interactive entertainment interface. It may be considered that conventional preview display of the target object may be performed before the wear trigger operation is performed on the effect wearable item in the application scenario. The target object original image may be regarded as a normal preview picture of a running relevant interactive entertainment application (for example, live streaming or a short video) for the target object in a normal state. The target object original image includes the target object. A wear body of the effect wearable item may be understood as a part at which the effect wearable item is to be worn, and the wear body of the effect wearable item is located on the target object.

In this embodiment, after the effect blocking three-dimensional model required for rendering is obtained, the target object is not directly rendered based on the effect blocking three-dimensional model, but the currently displayed target object original image including the target object needs to be acquired. In addition, the target object original image is further processed, to obtain an object contour image of the target object. The object contour image of the target object may be specifically understood as a contour image that segments the target object from the background. A manner of determining the object contour image of the target object original image may be understood as performing target object detection on the target object original image, so as to separate the target object from the background and obtain the object contour image of the target object.

In this embodiment, the purpose of determining to obtain an object contour image may be understood as follows: the target object is segmented from the background in the target object original image, and after segmentation, a specific region of the target object in the image, which regions that the target object occupies in the image, a special region of the effect wearable item, and which regions that the effect wearable item occupies in the image are learned. For example, assuming that the application scenario is to wear the effect hat to the head of a person, the person may be regarded as the target object, and the head of the person may be regarded as the wear body. The object contour image including only the person is obtained based on processing of the target object original image. It is equivalent to obtaining which regions that the person occupies in the image and a specific presentation form thereof, and which regions that the head of the person occupies in the image and a specific presentation form thereof.

For example, to express the object contour image of the target object original image more clearly, an example in which the effect hat is worn to the head of the person is used for description. FIG. 3 is a schematic diagram of an object contour image during execution of a method for effect processing according to an embodiment of the present disclosure As shown in FIG. 3, the object contour image 13 is divided into a target object 131 and a background part 132.

S230, based on the effect blocking three-dimensional model in combination with the object contour image, determining and displaying an effect combined image.

In this embodiment, when the effect blocking three-dimensional model and the object contour image are obtained, fusion rendering may be performed on this basis, to obtain an effect image after the effect wearable item is worn, and the effect image is denoted as the effect combined image. After the effect combined image is determined, the effect combined image may be presented on a display interface, and presentation effect is that the effect wearable item is worn on the target object.

In this embodiment, this step may present a combined picture formed in response to the foregoing wear trigger operation, and the combined picture may be denoted as the effect combined picture. It can be learned that the presentation effect that needs to be achieved by the effect wearable item is to present the effect wearable item on the part of the target object that the participant or the support person expects to present the effect wearable item. For example, it is expected that the effect hat can be presented on the top of the head of the target object and block hair on the top of the head and on both sides of the cars, and it is expected that the effect necklace can be presented on the neck of the target object and block the skin on the neck at the position at which the effect necklace is worn.

Specifically, in this embodiment, a picture presented on a display screen of the electronic device in response to the wear trigger operation on the effect wearable item may be denoted as the effect combined picture. To be specific, the effect combined picture presented in this step may be formed after a wear trigger operation is performed on an effect wearable item. The effect combined picture may be regarded as a combination of a target preview picture associated with the target object and a picture obtained after the effect wearable item is rendered. The effect wearable item in the effect combined picture is presented at a position at which the effect wearable item needs to be worn on the target object. In addition, to reflect reality of the effect wearable item being worn at a particular position or part of the target object, the back edge of the effect wearable item needs to be blocked by content originally presented by the target object.

Generally, when the target object wears the effect wearable item, the real effect should be as follows: in the picture presented to the user, there is a blocking relationship between the back part of the effect wearable item and the target object. In this case, it should be presented that the target object blocks the effect wearable item. For example, assuming that the target object is a person's head, and the effect wearable item is the effect hat, for a real scenario, after the person wears the hat, a picture presented by the front side of the person to another person is that the person's hair is located inside the hat, that is, the back edge part of the hat is blocked. Similarly, for an augmented reality scenario, after the person wears the effect hat in the scenario, it should also be ensured that the hair is located inside the hat, and the back edge of the hat is blocked by the hair, so that the combined image is reflected more realistically and more naturally.

To achieve the foregoing objective, in this embodiment, the effect wearable item is blocked based on an outer contour of the entire target object. After the effect blocking three-dimensional model is obtained, the placing position of the blocking two-dimensional plane in the effect blocking three-dimensional model is actually equivalent to blocking the back part of the effect wearable item. This part involves the back edge of the effect wearable item and a part of the target object that links up the effect wearable item. Following on from the foregoing example for description, the placing position of the two-dimensional blocking plane involves the back edge of the hat and the hair, the cars, and other parts of the person. These parts are parts in which the effect wearable item and the target object block each other. The front edge part of the effect wearable item can be directly presented on the top layer without interacting with the target object.

Following on from the foregoing description, the two-dimensional blocking plane part involved in the effect blocking three-dimensional model needs to be filled and rendered again, and this part involves the back edge of the effect wearable item and the target object between which there is a blocking relationship. Therefore, which part needs to be filled as the original target object and which part needs to be filled as the effect wearable item need to be determined. For example, which part is to be filled as the human face part and which part is to be filled as the back edge part of the hat need to be determined. How to divide the two parts needs to be determined based on the object contour image.

In this embodiment, the two-dimensional blocking plane is disposed in the effect blocking three-dimensional model, so that only the front part of the effect three-dimensional model can be presented during rendering, and the back part of the effect three-dimensional model is first blocked as an interfering part, and then filling is implemented based on subsequent processing. The object contour image is obtained by segmenting the target object from the background in the target object original image, and after segmentation, a specific region of the target object in the image, which regions that the target object occupies in the image, and which regions that the effect wearable item occupies in the image are learned.

For example, assuming that the target object is a person and the effect wearable item is an effect hat, the effect blocking three-dimensional model is a combination of the three-dimensional model of the hat and the two-dimensional blocking plane. In this effect blocking three-dimensional model, the front edge part of the hat can be presented, and the back edge part of the hat is blocked by the two-dimensional blocking plane. When the object contour image is a contour image of a person, the contour image is obtained by segmenting the person from the background, so that which regions that the human face occupies in the image can be determined. Two-dimensional conversion rendering is performed on the effect blocking three-dimensional model itself, and the hat is just pasted to the image during presentation. However, if only the hat model is rendered actually, a hat model and the two-dimensional blocking plane are obtained through rendering.

In this embodiment, a two-dimensional projection including a projection of the front edge part of the effect wearable item and a projection of the two-dimensional blocking plane is obtained after two-dimensional conversion rendering is performed based on the effect blocking three-dimensional model, where the front edge part of the effect wearable item covers the projection of the two-dimensional blocking plane. A region that corresponds to the contour image and that is included in the projection rendering region may be determined with reference to the object contour image. The projection rendering region is replaced with the corresponding region in the object contour image. For example, considering that sizes of the images are the same, pixels are in a one-to-one correspondence. In this case, corresponding pixel coordinates in this region may correspond to pixel coordinates in the object contour image, and pixel information of the pixels in the projection rendering region is replaced with pixel information of corresponding pixels in the object contour image.

Following on from the foregoing description, after the projection rendering region is replaced based on the object contour image, which part in which the target object should be presented and which part the effect wearable item should be presented may be determined based on the contour image of the region after replacement. After this region is known, filling based on a corresponding specific case may be considered. For example, following on from the foregoing example for description, the part that the human face actually occupies in this region may be determined based on the contour image of the person after replacement, and a human face may be obtained through rendering in this part for human face filling. In the background part, a part with a hat may also be obtained through rendering based on the two-dimensional conversion projection of the effect wearable item.

It may be understood that, only the front edge of the hat and a plane are obtained through rendering based on the effect blocking three-dimensional model, and the object contour includes only some contours of the target object. To form a combined image, some pixel information of this part in the target object original image needs to be combined. When the pixel information is used for filling, an image obtained by fusing the effect wearable item and the target object may be formed, because the information in the blocking plane has been segmented for filling in different parts. After the logical processing, a case in which the hat is located behind the hair does not occur. The back part of the hat has been blocked. In these parts in which the hair possibly needs to be presented, the hair has been presented through segmentation. In this way, it is possible that an area for presenting the hat is redundant on both sides in this region. Actually, it is equivalent, in the sense of layers, to being capable of presenting the effect that the hair is presented in front of the hat after the hair is presented.

Using a scenario in which a character wears an effect hat as an example, in a method, only the part of the head of a person is considered to form an effect combined image, and during fusion rendering, only the hat and a detected head model of the head are simply fused for rendering, and a relationship between the hair and the hat is not considered after rendering, causing unnatural edges. In this embodiment, the entire contour of the entire target object is considered, not only the head is used as a rendering target, not only a manner of combination between the hat and the head is considered, but a combination relationship between the hat and the entire person is considered.

Further, to form the effect combined image, an image further needs to be pasted to the target object original image. Considering that the background part of the entire image and some parts in the target object are not presented, the image obtained through rendering fusion is further fused with the target object original image in this embodiment, to implement the entire effect processing process, where the image obtained after processing is denoted as the effect combined image. The effect combined image may be displayed as a final image.

It should be known that the effect combined image obtained after processing may still have some problems of unblocking. For example, the hair on top of the head in the effect combined image obtained after processing cannot be well blocked by the wearable item, that is, some of the hair is exposed outside the hat after fusion. In this case, reshaping adjustment needs to be performed on the target object original image to be fused, the size of the target object original image is reduced, and then fusion is performed after adjustment.

This embodiment provides a method for effect processing. In the method, model blocking processing is first performed on the effect three-dimensional model of the effect wearable item in response to the wear trigger operation on the effect wearable item, to obtain the effect blocking three-dimensional model; then the currently displayed target object original image including the target object is obtained, and the object contour image of the target object original image is determined, where the wear body of the effect wearable item is located on the target object; and finally, based on the effect blocking three-dimensional model in combination with the object contour image, the effect combined image is determined and displayed. This resolves the problems that the effect wearable item is not closely attached to the wear part, edges link up unnaturally, and sense of reality is poor. In the foregoing technical solution, a two-dimensional blocking plane is set for the effect three-dimensional model of the effect wearable item, to block the part that is of the back part of the effect wearable item and that should be blocked during actual presentation; then the target object is segmented from the background based on the object contour image, so that fusion is performed based on the effect blocking three-dimensional model and the object contour image, and then the region obtained through fusion may be divided into the region involving the target object and the region involving the background; the target object is presented in the target object region, and the effect wearable item is presented in the background region, so that in the effect combined image presented in this combination, the target object can be covered in the effect wearable item, and in the presented image, edges of the target object and the effect wearable item link up more realistically and more naturally, to improve the effect presentation effect, thereby improving use experience of the participant for the augmented reality effect prop.

To better understand the foregoing method for effect processing provided in this embodiment, this embodiment is described by using a trial wear scenario of the effect hat. First, an effect hat trial wear functional module of entertainment application software may be first entered. After the effect hat function is entered, image information of a target object serving as a participant may be captured, and the image information is used as a current preview picture frame and presented in a preview interface. In the effect hat trial wear function, different styles and types of effect hats may be first presented to the participant, and the participant may choose an effect that the participant wants to try, and generate a wear trigger operation on the effect hat by selecting the effect hat. In the method provided in this embodiment, an effect combined picture including the participant and the effect hat may be displayed in response to the wear trigger operation.

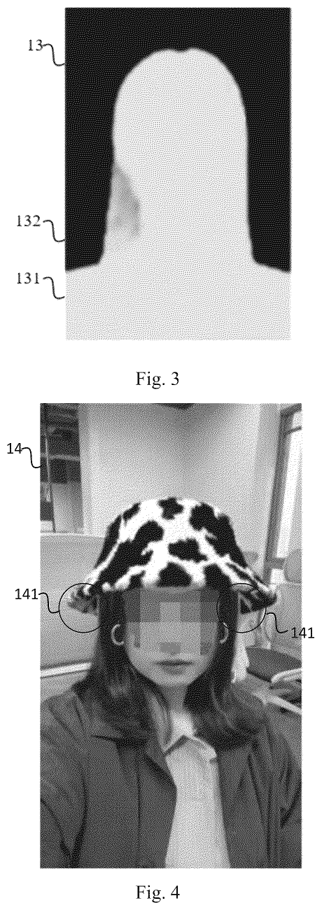

FIG. 4 is a schematic diagram of presentation of an effect wearable item after processing is performed by using a method for effect processing according to an embodiment of the present disclosure As shown in FIG. 4, the effect combined image 14 obtained through combined rendering of the effect hat and the head of person is specifically displayed. It can be found that, compared with FIG. 1, in the region 141 that links up the effect hat and the hair in the effect combined image 14, it can be seen that a part of the back edge of the effect is blocked by the hair, and the hair that blocks the part of the back edge of the hat and that should be displayed is normally displayed. It can be learned that, the effect combined picture presented through processing based on the method provided in this embodiment better displays the wear effect of the effect wearable item.

Based on the foregoing embodiment, an implementation of performing model blocking processing on the effect three-dimensional model of the effect wearable item, to obtain the effect blocking three-dimensional model may be optimized as the following steps.

a1) based on model vertex information of the effect three-dimensional model, constructing a two-dimensional blocking plane, and determining a plane placing position that meets a condition from the effect three-dimensional model.

In this embodiment, a process of forming the effect blocking three-dimensional model may be understood as processing the effect three-dimensional model in an editing tool of the effect three-dimensional model, to form the effect blocking three-dimensional model. A two-dimensional blocking plane needs to be formed for the effect three-dimensional model first, and the two-dimensional blocking plane and the effect three-dimensional model are fused to form a new model as the effect blocking three-dimensional model. The effect blocking three-dimensional model includes two parts: the effect three-dimensional model and the two-dimensional blocking plane. For example, a part of an effect blocking three-dimensional model of an effect hat is an original three-dimensional model part of the hat, and the other part is a to-be-constructed two-dimensional blocking plane. This means that to obtain the effect blocking three-dimensional model, at least one two-dimensional blocking plane is required, and a position at which the two-dimensional blocking plane is to be placed needs to be determined.

For example, an example in which a human body wears the effect hat is used for description. In an effect processing manner, in a picture formed by performing two-dimensional rendering projection on the effect three-dimensional model, regions of the parts of the back edge and the front edge of the hat are both displayed. If this image is combined with the target object original image, not only the front edge of the hat but also the back edge of the hat are presented in the formed image, and this does not conform to the real scenario. Therefore, the effect three-dimensional model is improved. To enable the back edge of the hat to be blocked during actual fusion, there is first a blocking panel in the effect three-dimensional model, so that a two-dimensional image formed during projection of the three-dimensional model can present only the front edge of the hat, and only the part of the front edge of the hat can be seen, and the part of the back edge of the hat is blocked first. In this way, real underlying support is provided for subsequent rendering.

It may be understood that, after the effect wearable item is selected, related information of the effect three-dimensional model corresponding to the effect wearable item may be obtained. In this step, model vertex information of the effect three-dimensional model, for example, which vertexes are included in the effect three-dimensional model, and coordinate information of the vertexes, may be obtained. After the model vertex information of the effect three-dimensional model is obtained, bottom vertexes of the effect three-dimensional model may be determined based on the model vertex information of the effect three-dimensional model; a bottom plane may be determined based on the bottom vertexes, where the bottom plane includes a maximum plane length value and a central axis; a height value of the blocking plane may be determined based on the target object; and the two-dimensional blocking plane may be determined based on the maximum plane length value and the height value.

Following on from the foregoing description, after the bottom plane is determined based on the bottom vertexes, the central axis included in the bottom plane may be determined. For example, position information of the central axis is determined as plane placing position information. For example, when the central axis is selected as the plane placing position, it can be ensured that regardless of how the target object rotates, the corresponding two-dimensional blocking plane rotates with the target object, so as to ensure the blocking effect.

b1) combining the two-dimensional blocking plane with the effect three-dimensional model at the plane placing position, to obtain the effect blocking three-dimensional model obtained through combination.

In this step, after the two-dimensional blocking plane and the plane placing position of the two-dimensional blocking plane are obtained, the two-dimensional blocking plane may be placed at the plane placing position, so that the two-dimensional blocking plane is combined with the effect three-dimensional model, to obtain a three-dimensional model that includes the blocking plane and that is obtained through combination, where the three-dimensional model is denoted as the effect blocking three-dimensional model.

It should be known that, if two-dimensional projection conversion is directly performed on the effect three-dimensional model, the back part of the effect three-dimensional model may also be displayed. In this embodiment, after blocking processing is performed on the effect three-dimensional model by using the two-dimensional blocking plane, that is, the effect three-dimensional model is combined with the two-dimensional blocking plane, when two-dimensional projection is performed after the blocking plane is constructed, the back part of the back edge of the effect three-dimensional model is blocked and cannot be seen. This can ensure that the back part of the effect wearable item is not rendered during subsequent rendering, so as to ensure reality of the wear effect of the effect wearable item.

Based on the foregoing embodiment, the step of performing model blocking processing on the effect three-dimensional model of the effect wearable item to obtain the effect blocking three-dimensional model is specified. A two-dimensional blocking plane and a position at which the two-dimensional blocking plane should be placed are determined based on the model vertex information of the effect three-dimensional model, so as to place the two-dimensional blocking plane at the position for combination into the effect blocking three-dimensional model. The back part of the effect three-dimensional model is blocked, so that when two-dimensional projection is performed on the effect three-dimensional model, the back part of the effect three-dimensional model is not presented, so as to ensure that the back part of the hat is not presented during subsequent rendering, thereby improving reality of the wear effect of the effect wearable item.

In a specific implementation, an implementation of constructing the two-dimensional blocking plane and determining a plane placing position that meets a condition from the effect three-dimensional model based on the model vertex information of the effect three-dimensional model may be optimized as the following steps.

a11) based on the model vertex information of the effect three-dimensional model, determining a maximum plane length value and a central axis of a bottom plane formed by bottom vertexes of the effect three-dimensional model.

In this optional embodiment, to implement the effect blocking three-dimensional model, a two-dimensional blocking plane and a plane placing position are required. Specifically, the model vertex information of the effect three-dimensional model is acquired, the bottom vertexes of the effect three-dimensional model may be determined based on the model vertex information, and the bottom plane may be formed based on the bottom vertexes. A maximum length value can be found by calculating two edge points of the bottom plane, and the length value is denoted as the maximum plane length of the bottom plane in this embodiment. In addition, after the bottom plane is determined, a form of the bottom plane is known. In this way, the central axis of the bottom plane can be found.

Generally, the effect wearable item is symmetric. For example, a hat, a watch, and a necklace are all symmetric. Therefore, the bottom is a symmetric graph, and a line of symmetry is referred to as the central axis.

a12) determining a blocking plane width value based on the maximum plane length value, and constructing the two-dimensional blocking plane in combination with a pre-obtained blocking plane height value.

In this embodiment, when the two-dimensional blocking plane is formed, the blocking plane width value should at least ensure that the back part of the effect three-dimensional model can be blocked. Therefore, the blocking plane width value may be determined based on the maximum plane length value. For example, the blocking plane width value may be set to be greater than the maximum plane length value, or the blocking plane width value may be set to be equal to the maximum plane length value.

With respect to the pre-obtained blocking plane height value, a proper height value can be provided through a logic based on a height of the target object, and is denoted as the blocking plane height value. Alternatively, a default value may be set and manually adjusted. A two-dimensional blocking plane may be formed based on the determined blocking plane width value and the blocking plane height value. It is considered that when the target object wears the wearable item, there is a blocking relationship between the wearable item and the target object. In this embodiment, a part that should be blocked is covered and blocked by the two-dimensional blocking plane. Different two-dimensional blocking planes need to be disposed for different articles.

For example, an article such as a watch or a hat has a part in a blocking relationship with a human body, and the part is blocked by the two-dimensional blocking plane. For example, when the effect hat is worn to the head of the person, the maximum plane length value of the bottom plane may be determined based on the model vertex information of the effect three-dimensional model of the effect hat, and the width value of the two-dimensional blocking plane is determined based on the maximum plane value. Then, a height value is determined based on a head model of the person, or a height value is determined based on an empirical value. A two-dimensional plane may be constructed as the two-dimensional blocking plane based on the width value and the height value. The two-dimensional blocking plane is intended to block a part that should be blocked of the hat. The central axis of the bottom plane can be determined at the same time.

a13) determining position information of the central axis as the plane placing position.

The central axis may be understood as being formed by several points, and position information of the several points jointly forms position information of the central axis. The position information of the central axis is determined as the plane placing position in this embodiment.

The foregoing technical solution specifies the steps of constructing the two-dimensional blocking plane and determining the plane placing position based on the model vertex information of the effect three-dimensional model. To be specific, the maximum plane length value and the central axis of the bottom plane of the effect three-dimensional model are determined based on the model vertex information of the effect three-dimensional model; and the two-dimensional blocking plane is formed based on the maximum length value and the pre-obtained width value, and the position information of the central axis of the bottom plane is used as the placing position of the two-dimensional blocking plane. The proper two-dimensional blocking plane and the proper plane placing position are set to provide basic support for forming the effect blocking three-dimensional model.

In an embodiment of the present disclosure, an implementation of determining the effect combined image based on the effect blocking three-dimensional model in combination with the object contour image, and displaying the effect combined image may be optimized as the following steps.

a2) performing two-dimensional conversion rendering on the effect blocking three-dimensional model to obtain an effect processing intermediate image, where the effect processing intermediate image includes a plane rendering region of a two-dimensional blocking plane used for effect processing.

In the embodiment, performing two-dimensional conversion rendering on the effect blocking three-dimensional model is equivalent to performing projection conversion on the effect blocking three-dimensional model, so as to obtain an image obtained through conversion rendering, which is denoted as the effect processing intermediate image. The formed effect processing intermediate image not only includes a region of a part of a projection of the effect wearable item, but also includes a region of a projection of the two-dimensional blocking plane used for effect processing, which is denoted as the plane rendering region in this embodiment.

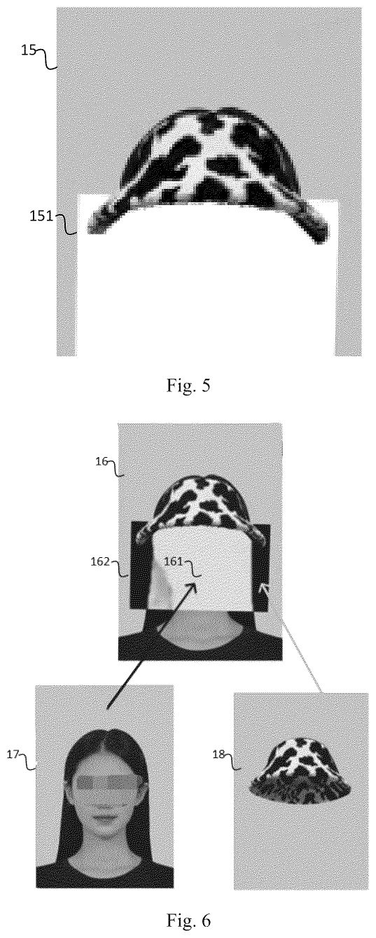

For example, to express the effect processing intermediate image more clearly, an example in which the effect wearable item is the effect hat is used for description in this embodiment. FIG. 5 is a schematic diagram of an effect processing intermediate image during execution of a method for effect processing according to an embodiment of the present disclosure. As shown in FIG. 5, two-dimensional conversion rendering is performed on the effect blocking three-dimensional model corresponding to the effect hat, to obtain the effect processing intermediate image 15, where the effect processing intermediate image 15 includes a projection of the hat and a projection of the two-dimensional blocking plane. A projection region of the two-dimensional blocking plane is the plane rendering region 151.

b2) performing image replacement on the plane rendering region of the effect processing intermediate image based on the object contour image, to obtain a first effect processing image after the image replacement.

The plane rendering region in the effect processing intermediate image is replaced based on the object contour image, that is, a corresponding region in the effect processing intermediate image is replaced with the object contour image, and an image obtained through replacement is referred to as the first effect processing image.

It may be understood that the object contour image consists of several pixels, and similarly, the effect processing intermediate image also consists of several pixels. It may be considered that the object contour image and the effect processing intermediate image are images with the same size. Correspondingly, a region on the object contour image may correspond to the effect processing intermediate image. Based on this, after pixel coordinates of pixels that correspond to the plane rendering region and that are on the effect intermediate rendering image are determined, pixel coordinates of pixels that are of a corresponding region in the object contour image may be found in the object contour image. Further, pixel information of these pixels in the object contour image can be obtained, to replace the pixel information of these pixels in the effect intermediate rendering image, so as to form a new image, denoted as the first effect processing image.

In a specific implementation, an implementation of performing image replacement on the plane rendering region of the effect processing intermediate image based on the object contour image, to obtain the first effect processing image obtained after image replacement may be optimized as the following steps.

b21) determining pixel coordinates of corresponding pixels of the plane rendering region on the effect processing intermediate image.

The effect processing intermediate image consists of several pixels, and each pixel has a corresponding pixel coordinate and a corresponding pixel value. Specifically, after the plane rendering region is known, pixel coordinates of pixels that correspond to the plane rendering region and that are on the effect processing intermediate image may be determined.

b22) searching the object contour image for contour pixel information of pixels corresponding to the pixel coordinates.

Because the object contour image and the effect processing intermediate image have a same size, pixels in the object contour image and pixels in the effect processing intermediate image are in a one-to-one correspondence. After the pixel coordinates of pixels that correspond to the plane rendering region and that are on the effect processing intermediate image are known, corresponding pixels that have the same pixel coordinates may be searched for on the object contour image based on the pixel coordinates. Pixel values of the pixels on the object contour image may be further obtained, and are denoted as contour pixel information.

b23) replacing plane pixel information of pixels in the plane rendering region with the contour pixel information, to construct a contour filling region.

In this embodiment, pixel information of the pixels in the plane rendering region is denoted as the plane pixel information. After the contour pixel information is obtained, the plane pixel information of the pixels in the plane rendering region may be replaced with the contour pixel information, so as to form the contour filling region. This process may be understood as replacing the pixel values of the plane pixels with the pixel values of the contour pixels, to obtain the contour filling region.

b24) determining an image including the contour filling region as the first effect processing image.

In this embodiment, after the contour filling region is formed, the image including the contour filling region is determined as the first effect processing image.

The foregoing technical solution specifies the step of determining the first effect processing image. That is, the pixel information of the pixels in the plane rendering region of the effect processing intermediate image is replaced based on the object contour image through the correspondence between the pixels of the object contour image and the pixels of the effect processing intermediate image, to implement image replacement on the plane rendering region, so as to obtain the first effect processing image obtained through image replacement. The target object part and the background part may be segmented through image replacement, to provide basis for subsequent separate rendering on the two parts.

c2) performing color filling on the first effect processing image according to a set color filling strategy, to obtain a second effect processing image after the color filling.

In this embodiment, the first effect processing image is obtained by performing image replacement on the plane rendering region of the effect processing intermediate image based on the object contour image. Because the contour filling region in the first effect processing image is not filled with color based on an actual situation, a region that involves the target object and that is in the contour filling region is white, and a part that involves the background is black, and the first effect processing image cannot be directly fused with the target object original image. Therefore, color filling needs to be performed on the first effect processing image.

It may be understood that, for the two parts involved in the contour filling region in the first effect processing image, one part corresponds to the target object, and the other part corresponds to the effect wearable item. When the contour filling region in the first effect processing image is filled, the contour filling region may be divided into two parts, and the two parts are separately filled based on corresponding images. The region that involves the target object and that is in the contour filling region may be filled based on the target object original image. The region that involves the background and that is in the contour filling region may be filled based on an effect original rendering image obtained by performing two-dimensional conversion rendering on the effect wearable item. After the contour filling region is completely filled, a formed image is denoted as the second effect processing image.

In a specific implementation, an implementation of performing color filling on the first effect processing image according to the set color filling strategy, to obtain the second effect processing image obtained after color filling may be optimized as the following steps.

c21) determining a contour background region and an object contour region from a contour filling region of the first effect processing image.

The contour filling region of the first effect processing image involves the region corresponding to the target object and the background region. Based on this, two regions are determined from the contour filling region of the first effect processing image. The region that involves the background is denoted as the contour background region, and the region that involves the target object is denoted as the object contour region.

For example, to express the first effect processing image more clearly, an example in which the effect wearable item is the effect hat is used for description in this embodiment. Following on from the foregoing example for description, FIG. 6 is a schematic diagram of a first effect processing image during execution of a method for effect processing according to an embodiment of the present disclosure. As shown in FIG. 6, the first effect processing image 16 includes the object contour region 161 and the contour background region 162.

c22) searching the target object original image for object pixel coordinates corresponding to the object contour region, and filling pixel values of the object pixel coordinates into the object contour region.

In this embodiment, the object contour region is filled based on the target object original image. Pixels included in the object contour region and pixel coordinates of the pixels can be determined. The target object original image is searched for pixel coordinates the same as pixel coordinates of pixels in the object contour region, and the found pixel coordinates are denoted as object pixel coordinates. Pixel values corresponding to the object pixel coordinates in the target object original image may be further obtained, and these pixel values are filled into the object contour region based on a correspondence. The object contour region can be filled in this step, and the filled object contour region presents corresponding content of the target object.

c23) searching a predetermined effect original rendering image for background pixel coordinates corresponding to the contour background region, and filling pixel values of the background pixel coordinates into the contour background region.

A step of determining the effect original rendering image may be performing two-dimensional conversion rendering on the effect wearable item, to obtain an image obtained through rendering, which is denoted as the effect original rendering image.

In this optional embodiment, the contour background region is filled based on the effect original rendering image. Pixels included in the contour background region and pixel coordinates of the pixels can be determined. The effect original rendering image is searched for pixel coordinates the same as pixel coordinates of pixels in the contour background region, and the found pixel coordinates are denoted as background pixel coordinates. Pixel values corresponding to the background pixel coordinates in the effect original rendering image may be further obtained, and these pixel values are filled into the contour background region based on a correspondence. The contour background region can be filled in this step, and the filled contour background region presents corresponding content of the effect wearable item.

Still with reference to FIG. 6, the object contour region 161 may be filled based on the target object original image 17, and the contour background region 162 may be filled based on the effect original rendering image 18, to obtain the second effect processing image.

c24) denoting an image obtained after pixel value filling is performed on the object contour region and the contour background region as the second effect processing image.

In this optional embodiment, an image obtained after pixel value filling is performed on the object contour region and the contour background region is determined as the second effect processing image.

In the foregoing optional embodiment, a specific implementation of the step of determining the second effect processing image is provided. When the contour filling region is filled, the contour filling region may be divided into two parts, and the two parts are separately filled based on corresponding images. The region that involves the target object and that is in the contour filling region may be filled based on the target object original image. The region that involves the background and that is in the contour filling region may be filled based on an effect original rendering image obtained by performing two-dimensional conversion rendering on the effect wearable item. In this way, the target object and the background are separately rendered, to prevent a part that is of the effect wearable item and that should have been blocked from being presented on the target object, so that the target object and the effect wearable item link up more realistically and more naturally, thereby improving the wear effect of the effect wearable item.

d2) performing image fusion on the second effect processing image and the target object original image, to obtain and display the effect combined image after fusion.

Considering that the background part of the entire image and some parts in the target object are not presented, the second effect processing image and the target object original image are fused in this embodiment, to implement the entire effect processing process, where the image obtained after processing is denoted as the effect combined image. The effect combined image may be displayed as a final image.

The foregoing technical solution specifies the step of determining the effect combined image based on the effect blocking three-dimensional model in combination with the object contour image. Two-dimensional conversion rendering is performed on the effect blocking three-dimensional model. Due to existence of the two-dimensional blocking plane, a part that is in the back part of the effect blocking three-dimensional model and that should not be displayed can be blocked, so that only the front part of the effect three-dimensional model is presented during projection. The plane rendering region corresponding to the two-dimensional blocking plane is further replaced based on the object contour image, to ensure that the target region is segmented from the background in this region. Then different regions are separately rendered, to prevent a part that is of the effect wearable item and that should have been blocked from being presented on the target object, so that the target object and the effect wearable item link up more realistically and more naturally, thereby improving the wear effect of the effect wearable item.

Currently, there are many facial beautification algorithms that can be used to perform a reshaping beautification operation on the target object, for example, a facial slimming operation on a human face. After the facial slimming operation is performed, if an original coverage range is still used, a facial coverage range is greater than a real user face. Consequently, after blocking is performed, there is a gap between the hat and the human face. In the following optional embodiment, a step of updating the object contour image is added for this case.

Based on the foregoing embodiment, a function of performing a reshaping beautification operation on a selected body on the target object may be further added, and the following steps are further optimized and added.

a3) when a reshaping beautification operation on a selected body on the target object is detected, acquiring selected body reshaping information corresponding to the reshaping beautification operation.

The reshaping beautification operation may be specifically understood as an operation of making the selected body in the target object smaller. The selected body on the target object may be a particular part on the target object. If it is detected that the reshaping beautification operation on the selected body on the target object is, for example, a facial slimming operation on a human image, the human face is the selected body.

Considering that the width originally occupied by the selected body of the target object becomes smaller after the reshaping operation is performed, if the object contour image and the effect blocking three-dimensional model are directly processed, there is a gap between the effect wearable item and the selected body of the target object. Therefore, this gap needs to be shortened to make blocking closer. The specific amount by which the gap needs to be shortened is related to reshaping information generated during the reshaping beautification operation, and the reshaping information corresponding to the reshaping beautification operation is denoted in this embodiment as selected body reshaping information.

Therefore, when a reshaping beautification operation on the selected body on the target object is detected, the selected body reshaping information corresponding to the reshaping beautification operation needs to be first obtained. The selected body reshaping information may be understood as information about to what extent the selected body is reshaped. For example, assuming that the target object is a person and the selected body is a human face, and the reshaping beautification operation is performed on the human face, for example, slimming the face by 10% or slimming the face by 20%, slimming the face by 10% or slimming the face by 20% may be regarded as reshaping information on the human face.

b3) updating the object contour image based on the selected body reshaping information.

In this optional embodiment, after the selected body reshaping information is determined, the degree of reshaping of the selected body is known. The quantity of times of scale-down of the object contour image is determined based on the degree of reshaping. In addition, pixel values of pixels on the contour are updated based on a pixel value update strategy. For example, for a place that needs to be scaled down, pixel values that originally represent the contour are changed, through pixel value update, to pixel values that represent the background. The object contour image is updated based on the determined quantity of update times, to obtain an object contour image obtained through scale-down.

After the function of performing the reshaping beautification operation on the selected body on the target object is added in the foregoing technical solution, the object contour image needs to be updated. The selected body reshaping information corresponding to the reshaping beautification operation is obtained, to update the object contour image based on the selected body reshaping information, so that after the reshaping beautification operation is performed on the selected body on the target object, it can be still ensured that the target object and the effect wearable item link up more realistically and more naturally, thereby improving the wear effect of the effect wearable item.

In a specific implementation, an implementation of updating the object contour image based on the selected body reshaping information may be optimized as the following steps.

b31) determining a quantity of times of update cycle of the object contour image based on the selected body reshaping information.

After the selected body reshaping information is determined, the quantity of times of update cycle of the object contour image corresponding to the selected body reshaping information may be determined based on the selected body reshaping information. The selected body reshaping information represents the degree of reshaping of the selected body. For example, the degree of reshaping may be a value in the range of 0 to 100%. The degree of reshaping in the selected body reshaping information is determined to determine which pixels need to be updated, to be specific, which parts need to be changed from the object contour to the background part.

After replacement processing is directly performed on the object contour image and the effect blocking three-dimensional model after the reshaping beautification operation, if the formed blocking part is rendered based on a reshaped target object original image, there is a gap between the effect wearable item and the selected body. Therefore, the blocking part needs to be scaled down in this embodiment, to ensure that the effect wearable item and the selected body also link up naturally after reshaping is performed.

When the object contour image is updated, the quantity of times of update cycle required for the object contour image needs to be first determined based on the selected body reshaping information, or it may also be understood as determining the quantity of times for which the object contour image needs to be eroded, that is, the quantity of times of erosion processing.

b32) performing pixel value update on all pixels in the object contour image according to a set pixel value update strategy.

To resolve the problem of the gap between the effect wearable item and the selected body of the target object, the object contour image needs to be adjusted, which is equivalent to scaling down the object contour image accordingly after performing the reshaping beautification operation on the selected object. Herein, all parts that need to be scaled down may be made black in the background part, and the pixel value update strategy is used for turning black.

The set pixel value update strategy is an erosion algorithm. In this case, the object contour image needs to be processed with reference to the erosion algorithm, to reduce a range of the object contour therein. In the erosion algorithm, some white pixels may be deleted along the contour of the white target object of the image, to further reduce the size of the coverage of the contour of the white object.

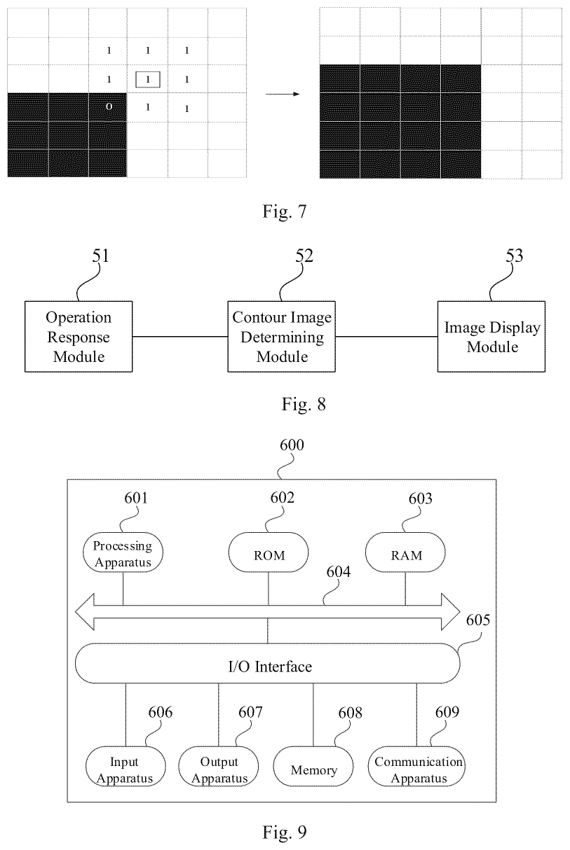

For example, to describe more clearly the principle of updating the pixel values of the pixels of the object contour image, FIG. 7 provides a principle diagram of an erosion algorithm during execution of a method for effect processing according to an embodiment of the present disclosure. As shown in FIG. 7, the principle of the erosion algorithm is as follows: a black pixel value is set to 0, and a white pixel value is set to 1. Using a pixel circled by the black box in the figure as an example, in this case, a sum of pixel values of the pixel and its surrounding pixels may be expressed as: a pixel value of this pixel+a pixel value of a left pixel+a pixel value of a right pixel+a pixel value of an upper pixel+a pixel value of a lower pixel+a pixel value of an upper left pixel+a pixel value of a lower left pixel+a pixel value of an upper right pixel point pixel+a pixel value of a lower right pixel, a final sum of the pixel values is equal to 8, and the sum of the pixel values is less than 9. Therefore, the pixel value of this pixel may be set to 0, that is, black is displayed. Otherwise, if the sum of the pixel values obtained through summation is 9, the pixel value of this pixel does not need to be updated.

It may be understood that pixel values of the pixels in the object contour image may be 0 and 1. The process of updating the pixel values of the pixels of the object contour image is the process of changing some white pixel values into black pixel values. One round of update is equivalent to performing erosion algorithm calculation on all pixels in the current object contour image, to update the object contour image.

b33) forming an updated object contour image based on updated pixel values of all the pixels, and adding 1 to a current update cycle count.

Specifically, the updated object contour image may be formed based on the updated pixel values of all the pixels. In addition, 1 is added to the current update cycle count.

b34) returning to re-perform the pixel value update until the current update cycle count is equal to the quantity of times of update cycle.

In this optional embodiment, after the pixel values of the pixels are updated once, whether one new update further needs to be performed on the pixel values needs to be determined. If the quantity of times of current update cycle is equivalent to a total quantity of times of update cycle, a new update does not need to be performed. The final object contour image obtained through update may be used as the final object contour image.

The foregoing technical solution specifies the step of updating the object contour image based on the selected body reshaping information. The required quantity of times of update cycle is first determined based on the selected body reshaping information, and then the object contour image is scaled down based on the pixel value update strategy, to finally obtain the updated object contour image. For subsequent processing based on the updated object contour image and the effect blocking three-dimensional model, the obtained effect combined image can ensure that the target object and the effect wearable item link up more realistically and more naturally, thereby improving the wear effect of the effect wearable item.

FIG. 8 is a schematic structural diagram of an apparatus for effect processing according to an embodiment of the present disclosure. As shown in FIG. 8, the apparatus includes: an operation response module 51, a contour image determining module 52, and an image display module 53.

The operation response module 51 is configured to, in response to a wear trigger operation on an effect wearable item, perform model blocking processing on an effect three-dimensional model of the effect wearable item to obtain an effect blocking three-dimensional model.

The contour image determining module 52 is configured to acquire a target object original image currently displayed including a target object, and determine an object contour image of the target object original image, where the wear body of the effect wearable item is located on the target object.

The image display module 53 is configured to determine and display an effect combined image based on the effect blocking three-dimensional model in combination with the object contour image.

The technical solution provided in this embodiment of the present disclose resolves the problems that the effect wearable item is not closely attached to the wear part, edges link up unnaturally, and sense of reality is poor. In the foregoing technical solution, a two-dimensional blocking plane is set for the effect three-dimensional model of the effect wearable item, to block the part that is of the back part of the effect wearable item and that should be blocked during actual presentation; then the target object is segmented from the background based on the object contour image, so that fusion is performed based on the effect blocking three-dimensional model and the object contour image, and then the region obtained through fusion may be divided into the region involving the target object and the region involving the background; the target object is presented in the target object region, and the effect wearable item is presented in the background region, so that in the effect combined image presented in this combination, the target object can be covered in the effect wearable item, and in the presented image, edges of the target object and the effect wearable item link up more realistically and more naturally, to improve the effect presentation effect, thereby improving use experience of the participant for the augmented reality effect prop.

Further, the operation response module 51 may include:
a plane construction unit, configured to, based on model vertex information of the effect three-dimensional model, construct a two-dimensional blocking plane, and determine a plane placing position that meets a condition from the effect three-dimensional model; and
a model combination unit, configured to combine the two-dimensional blocking plane with the effect three-dimensional model at the plane placing position, to obtain the effect blocking three-dimensional model obtained through combination.

Further, the plane construction unit may be specifically configured to:
based on the model vertex information of the effect three-dimensional model, determine a maximum plane length value and a central axis of a bottom plane formed by bottom vertexes of the effect three-dimensional model;
determine a blocking plane width value based on the maximum plane length value, and constructing the two-dimensional blocking plane in combination with a pre-obtained blocking plane height value; and
determine position information of the central axis as the plane placing position.

Further, the image display module 53 may include:
a first processing unit, configured to perform two-dimensional conversion rendering on the effect blocking three-dimensional model to obtain an effect processing intermediate image, where the effect processing intermediate image includes a plane rendering region of a two-dimensional blocking plane used for effect processing;
a second processing unit, configured to perform image replacement on the plane rendering region of the effect processing intermediate image based on the object contour image, to obtain a first effect processing image after the image replacement;
a third processing unit, configured to perform color filling on the first effect processing image according to a set color filling strategy, to obtain a second effect processing image after the color filling; and
a fourth processing unit, configured to perform image fusion on the second effect processing image and the target object original image, to obtain and display the effect combined image after fusion.

Further, the second processing unit may be specifically configured to:
determine pixel coordinates of corresponding pixels of the plane rendering region on the effect processing intermediate image;
search the object contour image for contour pixel information of pixels corresponding to the pixel coordinates;
replace plane pixel information of pixels in the plane rendering region with the contour pixel information, to construct a contour filling region; and
determine an image including the contour filling region as the first effect processing image.

Further, the third processing unit may be specifically configured to:
determine a contour background region and an object contour region from a contour filling region of the first effect processing image;
search the target object original image for object pixel coordinates corresponding to the object contour region, and fill pixel values of the object pixel coordinates into the object contour region;
search a predetermined effect original rendering image for background pixel coordinates corresponding to the contour background region, and fill pixel values of the background pixel coordinates into the contour background region; and
denote an image obtained after pixel value filling is performed on the object contour region and the contour background region as the second effect processing image.

Further, the apparatus further includes a reshaping determining module, where the reshaping determining module may specifically include:
an information determining unit, configured to, when a reshaping beautification operation on a selected body on the target object is detected, acquire selected body reshaping information corresponding to the reshaping beautification operation; and
an update unit, configured to update the object contour image based on the selected body reshaping information.

Further, the information determining unit may be specifically configured to:
determine a quantity of times of update cycle of the object contour image based on the selected body reshaping information;
perform pixel value update on all pixels in the object contour image according to a set pixel value update strategy;
form an updated object contour image based on updated pixel values of all the pixels, and add 1 to a current update cycle count; and
return to re-perform the pixel value update until the current update cycle count is equal to the quantity of times of update cycle.

The apparatus for effect processing provided in this embodiment of the present disclosure can perform the method for effect processing provided in any embodiment of the present disclosure, and has corresponding functional modules for performing the method and beneficial effects.

It is worth noting that the various units and modules included in the foregoing apparatus are only divided based on the functional logic, but are not limited to the foregoing division, provided that corresponding functions can be implemented. Furthermore, the specific names of the various functional units are only for the purpose of facilitating mutual differentiation, and are not intended to limit the scope of protection of the embodiments of the present disclosure.

FIG. 9 is a structural schematic diagram of an electronic device provided in an embodiment of the present disclosure. FIG. 9 is specifically referred below, and it shows the structural schematic diagram suitable for achieving the electronic device (e.g. a terminal device or a server in FIG. 9) 600 in the embodiment of the present disclosure. The terminal device in the embodiment of the present disclosure may include but not limited to a mobile terminal such as a mobile phone, a notebook computer, a digital broadcasting receiver, a personal digital assistant (PDA), a portable android device (PAD), a portable multimedia player (PMP), a vehicle terminal (such as a vehicle navigation terminal), and a fixed terminal such as a digital television (TV) and a desktop computer. The electronic device shown in FIG. 9 is only an example and should not bring any limitation to the scope of functionality and use of embodiments of the present disclosure.

As shown in FIG. 9, the electronic device 600 may include a processing apparatus (such as a central processing unit, and a graphics processor) 601, the processing apparatus 601 may execute a plurality of appropriate actions and processes according to a program stored in a read-only memory (ROM) 602 or a program loaded from a memory 608 to a random-access memory (RAM) 603. In RAM 603, a plurality of programs and data required for operations of the electronic device 600 are also stored. The processing apparatus 601, ROM 602, and RAM 603 are connected to each other by a bus 604. An input/output (I/O) interface 605 is also connected to the bus 604.

Typically, the following apparatuses may be connected to the I/O interface 605: an input apparatus 606 such as a touch screen, a touchpad, a keyboard, a mouse, a camera, a microphone, an accelerometer, and a gyroscope; an output apparatus 607 such as a liquid crystal display (LCD), a loudspeaker, and a vibrator; a memory 608 such as a magnetic tape, and a hard disk drive; and a communication apparatus 609. The communication apparatus 609 may allow the electronic device 600 to wireless-communicate or wire-communicate with other devices so as to exchange data. Although FIG. 9 shows the electronic device 600 with a plurality of apparatuses, it is not required to implement or possess all the apparatuses shown. Alternatively, it may implement or possess the more or less apparatuses.

According to the embodiment of the present disclosure, the process described above with reference to the flowchart may be achieved as a computer software program. For example, an embodiment of the present disclosure includes a computer program product, it includes a computer program carried on a non-transitory computer-readable medium, and the computer program includes program codes for executing the method shown in the flowchart. In such an embodiment, the computer program may be downloaded and installed from the network by the communication apparatus 609, or installed from the memory 608, or installed from ROM 602. When the computer program is executed by the processing apparatus 601, the above functions defined in the method in the embodiments of the present disclosure are executed.

Names of messages or information exchanged between a plurality of apparatuses in embodiments of the present disclosure are only used for description and not meant to limit the scope of these messages or information.

The electronic device provided in the embodiments of the present disclosure belongs to the same inventive concept as the method for effect processing provided in the above embodiments, and technical details not exhaustively described in the present embodiments can be found in the above embodiments.

The embodiment of the disclosure provides a computer storage medium, on which computer programs are stored, and when the programs are executed by a processor, the method for effect processing provided by the above embodiment is realized.

It should be noted that the above computer-readable medium in the present disclosure may be a computer-readable signal medium, a computer-readable storage medium, or any combinations of the two. The computer-readable storage medium may be, but not limited to, for example, a system, an apparatus or a device of electricity, magnetism, light, electromagnetism, infrared, or semiconductor, or any combinations of the above. More examples of the computer-readable storage medium may include but not limited to: an electric connector with one or more wires, a portable computer magnetic disk, a hard disk drive, a RAM, a ROM, an erasable programmable read-only memory (EPROM) or flash memory, an optical fiber, a compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt a plurality of forms, including but not limited to an electromagnetic signal, an optical signal, or suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some embodiments, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable storage medium may be included in the electronic device described above, or may exist alone without being assembled into the electronic device.

The above-mentioned computer-readable medium carries one or more programs which, when executed by the electronic device, cause the electronic device to:

in response to a wear trigger operation on an effect wearable item, perform model blocking processing on an effect three-dimensional model of the effect wearable item to obtain an effect blocking three-dimensional model; acquire a target object original image currently displayed including a target object, and determine an object contour image of the target object original image, where the wear body of the effect wearable item is located on the target object; and based on the effect blocking three-dimensional model in combination with the object contour image, determine and display an effect combined image.

The computer program code for executing the operation of the present disclosure may be written in one or more programming languages or combinations thereof, the above programming language includes but not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flowcharts and the block diagrams in the drawings show possibly achieved system architectures, functions, and operations of systems, methods, and computer program products according to a plurality of embodiments of the present disclosure. At this point, each box in the flowchart or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flowchart, as well as combinations of the boxes in the block diagram and/or the flowchart, may be achieved by using a dedicated hardware-based system that performs the specified function or operation, or may be achieved by using combinations of dedicated hardware and computer instructions.

The units described in the embodiment of the present disclosure can be realized by software or hardware. The name of the unit does not constitute a limitation on the unit itself in some cases. For example, the first acquisition unit can also be described as “a unit that acquires at least two Internet protocol addresses”.

The functions described above in this article may be at least partially executed by at least one hardware logic component. For example, exemplary types of the hardware logic component that may be used include: a field programmable gate array (FPGA), an application specific integrated circuit (ASIC), an application specific standard part (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, Example 1 provides a method for effect processing, which includes: in response to a wear trigger operation on an effect wearable item, performing model blocking processing on an effect three-dimensional model of the effect wearable item to obtain an effect blocking three-dimensional model; acquiring a target object original image currently displayed including a target object, and determining an object contour image of the target object original image, where a wear body of the effect wearable item is located on the target object; and based on the effect blocking three-dimensional model in combination with the object contour image, determining and displaying an effect combined image.

According to one or more embodiments of the present disclosure, Example 2 provides a method for effect processing, which includes performing model blocking processing on an effect three-dimensional model of the effect wearable item to obtain an effect blocking three-dimensional model. The method may be further optimized as follows: based on model vertex information of the effect three-dimensional model, constructing a two-dimensional blocking plane, and determining a plane placing position that meets a condition from the effect three-dimensional model; and combining the two-dimensional blocking plane with the effect three-dimensional model at the plane placing position, to obtain the effect blocking three-dimensional model obtained through combination.

According to one or more embodiments of the present disclosure, Example 3 provides a method for effect processing, which includes based on model vertex information of the effect three-dimensional model, constructing a two-dimensional blocking plane, and determining a plane placing position that meets a condition from the effect three-dimensional model. The method may be further optimized as follows: based on the model vertex information of the effect three-dimensional model, determining a maximum plane length value and a central axis of a bottom plane formed by bottom vertexes of the effect three-dimensional model; determining a blocking plane width value based on the maximum plane length value, and constructing the two-dimensional blocking plane in combination with a pre-obtained blocking plane height value; and determining position information of the central axis as the plane placing position.

According to one or more embodiments of the present disclosure, Example 4 provides a method for effect processing, which includes based on the effect blocking three-dimensional model in combination with the object contour image, determining and displaying an effect combined image. The method may be further optimized as follows: performing two-dimensional conversion rendering on the effect blocking three-dimensional model to obtain an effect processing intermediate image, where the effect processing intermediate image includes a plane rendering region of a two-dimensional blocking plane used for effect processing; performing image replacement on the plane rendering region of the effect processing intermediate image based on the object contour image, to obtain a first effect processing image after the image replacement; performing color filling on the first effect processing image according to a set color filling strategy, to obtain a second effect processing image after the color filling; and performing image fusion on the second effect processing image and the target object original image, to obtain and display the effect combined image after fusion.

According to one or more embodiments of the present disclosure, Example 5 provides a method for effect processing, which includes performing image replacement on the plane rendering region of the effect processing intermediate image based on the object contour image, to obtain a first effect processing image after the image replacement. The method may be further optimized as follows: determining pixel coordinates of corresponding pixels of the plane rendering region on the effect processing intermediate image; searching the object contour image for contour pixel information of pixels corresponding to the pixel coordinates; replacing plane pixel information of pixels in the plane rendering region with the contour pixel information, to construct a contour filling region; and determining an image including the contour filling region as the first effect processing image.

According to one or more embodiments of the present disclosure, Example 6 provides a method for effect processing, which includes performing color filling on the first effect processing image according to a set color filling strategy, to obtain a second effect processing image after the color filling. The method may be further optimized as follows: determining a contour background region and an object contour region from a contour filling region of the first effect processing image; searching the target object original image for object pixel coordinates corresponding to the object contour region, and filling pixel values of the object pixel coordinates into the object contour region; searching a predetermined effect original rendering image for background pixel coordinates corresponding to the contour background region, and filling pixel values of the background pixel coordinates into the contour background region; and denoting an image obtained after pixel value filling is performed on the object contour region and the contour background region as the second effect processing image.

According to one or more embodiments of the present disclosure, Example 7 provides a method for effect processing, which further includes when a reshaping beautification operation on a selected body on the target object is detected, acquiring selected body reshaping information corresponding to the reshaping beautification operation; and updating the object contour image based on the selected body reshaping information.

According to one or more embodiments of the present disclosure, Example 8 provides a method for effect processing, which includes updating the object contour image based on the selected body reshaping information. The method may be further optimized as follows: determining a quantity of times of update cycle of the object contour image based on the selected body reshaping information; performing pixel value update on all pixels in the object contour image according to a set pixel value update strategy; forming an updated object contour image based on updated pixel values of all the pixels, and adding 1 to a current update cycle count; and returning to re-perform the pixel value update until the current update cycle count is equal to the quantity of times of update cycle.

According to one or more embodiments of the present disclosure, Example 9 provides an apparatus method for effect processing, which includes: an operation response module configured to, in response to a wear trigger operation on an effect wearable item, perform model blocking processing on an effect three-dimensional model of the effect wearable item to obtain an effect blocking three-dimensional model; a contour image determining module configured to acquire a target object original image currently displayed including a target object, and determine an object contour image of the target object original image, where the wear body of the effect wearable item is located on the target object; and an image display module configured to determine and display an effect combined image based on the effect blocking three-dimensional model in combination with the object contour image.

According to one or more embodiments of the present disclosure, Example 10 provides an electronic device, which includes one or more processors; and at least one memory, configured to store one or more programs, when the one or more programs are executed by the one or more processors, causing the one or more processors to implement the method for effect processing according to any one of the above examples 1-8.

According to one or more embodiments of the present disclosure, Example 11 provides a non-transient computer-readable storage medium, which includes computer-executable instructions, the computer-executable instructions when executed by a processor of a computer, implement the method for effect processing according to any one of the above examples 1-8.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for effect processing, comprising:
in response to a wear trigger operation on an effect wearable item, performing model blocking processing on an effect three-dimensional model of the effect wearable item to obtain an effect blocking three-dimensional model;
acquiring a target object original image currently displayed comprising a target object, and determining an object contour image of the target object original image, wherein a wear body of the effect wearable item is located on the target object; and
based on the effect blocking three-dimensional model in combination with the object contour image, determining and displaying an effect combined image.

2. The method according to claim 1, wherein the performing model blocking processing on an effect three-dimensional model of the effect wearable item to obtain an effect blocking three-dimensional model comprises:
based on model vertex information of the effect three-dimensional model, constructing a two-dimensional blocking plane, and determining a plane placing position that meets a condition from the effect three-dimensional model; and
combining the two-dimensional blocking plane with the effect three-dimensional model at the plane placing position, to obtain the effect blocking three-dimensional model obtained through combination.

3. The method according to claim 2, wherein the based on model vertex information of the effect three-dimensional model, constructing a two-dimensional blocking plane, and determining a plane placing position that meets a condition from the effect three-dimensional model comprises:
based on the model vertex information of the effect three-dimensional model, determining a maximum plane length value and a central axis of a bottom plane formed by bottom vertexes of the effect three-dimensional model;
determining a blocking plane width value based on the maximum plane length value, and constructing the two-dimensional blocking plane in combination with a pre-obtained blocking plane height value; and
determining position information of the central axis as the plane placing position.

4. The method according to claim 1, wherein the based on the effect blocking three-dimensional model in combination with the object contour image, determining and displaying an effect combined image comprises:
performing two-dimensional conversion rendering on the effect blocking three-dimensional model to obtain an effect processing intermediate image, wherein the effect processing intermediate image comprises a plane rendering region of a two-dimensional blocking plane used for effect processing;
performing image replacement on the plane rendering region of the effect processing intermediate image based on the object contour image, to obtain a first effect processing image after the image replacement;
performing color filling on the first effect processing image according to a set color filling strategy, to obtain a second effect processing image after the color filling; and
performing image fusion on the second effect processing image and the target object original image, to obtain and display the effect combined image after fusion.

5. The method according to claim 4, wherein the performing image replacement on the plane rendering region of the effect processing intermediate image based on the object contour image, to obtain a first effect processing image after the image replacement comprises:
determining pixel coordinates of corresponding pixels of the plane rendering region on the effect processing intermediate image;
searching the object contour image for contour pixel information of pixels corresponding to the pixel coordinates;
replacing plane pixel information of pixels in the plane rendering region with the contour pixel information, to construct a contour filling region; and
determining an image comprising the contour filling region as the first effect processing image.

6. The method according to claim 4, wherein the performing color filling on the first effect processing image according to a set color filling strategy, to obtain a second effect processing image after the color filling comprises:
determining a contour background region and an object contour region from a contour filling region of the first effect processing image;
searching the target object original image for object pixel coordinates corresponding to the object contour region, and filling pixel values of the object pixel coordinates into the object contour region;
searching a predetermined effect original rendering image for background pixel coordinates corresponding to the contour background region, and filling pixel values of the background pixel coordinates into the contour background region; and
denoting an image obtained after pixel value filling is performed on the object contour region and the contour background region as the second effect processing image.

7. The method according to claim 1, further comprising:
when a reshaping beautification operation on a selected body on the target object is detected, acquiring selected body reshaping information corresponding to the reshaping beautification operation; and
updating the object contour image based on the selected body reshaping information.

8. The method according to claim 7, wherein the updating the object contour image based on the selected body reshaping information comprises:
determining a quantity of times of update cycle of the object contour image based on the selected body reshaping information;
performing pixel value update on all pixels in the object contour image according to a set pixel value update strategy;
forming an updated object contour image based on updated pixel values of all the pixels, and adding 1 to a current update cycle count; and
returning to re-perform the pixel value update until the current update cycle count is equal to the quantity of times of update cycle.

9. An electronic device, comprising:
one or more processors; and
at least one memory, configured to store one or more programs,
wherein when the one or more programs are executed by the one or more processors, causing the one or more processors to implement a method for effect processing, and the method for effect processing comprises:
in response to a wear trigger operation on an effect wearable item, performing model blocking processing on an effect three-dimensional model of the effect wearable item to obtain an effect blocking three-dimensional model;
acquiring a target object original image currently displayed comprising a target object, and determining an object contour image of the target object original image, wherein a wear body of the effect wearable item is located on the target object; and
based on the effect blocking three-dimensional model in combination with the object contour image, determining and displaying an effect combined image.

10. The electronic device according to claim 9, wherein the performing model blocking processing on an effect three-dimensional model of the effect wearable item to obtain an effect blocking three-dimensional model comprises:
based on model vertex information of the effect three-dimensional model, constructing a two-dimensional blocking plane, and determining a plane placing position that meets a condition from the effect three-dimensional model; and
combining the two-dimensional blocking plane with the effect three-dimensional model at the plane placing position, to obtain the effect blocking three-dimensional model obtained through combination.

11. The electronic device according to claim 10, wherein the based on model vertex information of the effect three-dimensional model, constructing a two-dimensional blocking plane, and determining a plane placing position that meets a condition from the effect three-dimensional model comprises:
based on the model vertex information of the effect three-dimensional model, determining a maximum plane length value and a central axis of a bottom plane formed by bottom vertexes of the effect three-dimensional model;
determining a blocking plane width value based on the maximum plane length value, and constructing the two-dimensional blocking plane in combination with a pre-obtained blocking plane height value; and
determining position information of the central axis as the plane placing position.

12. The electronic device according to claim 9, wherein the based on the effect blocking three-dimensional model in combination with the object contour image, determining and displaying an effect combined image comprises:
performing two-dimensional conversion rendering on the effect blocking three-dimensional model to obtain an effect processing intermediate image, wherein the effect processing intermediate image comprises a plane rendering region of a two-dimensional blocking plane used for effect processing;
performing image replacement on the plane rendering region of the effect processing intermediate image based on the object contour image, to obtain a first effect processing image after the image replacement;
performing color filling on the first effect processing image according to a set color filling strategy, to obtain a second effect processing image after the color filling; and
performing image fusion on the second effect processing image and the target object original image, to obtain and display the effect combined image after fusion.

13. The electronic device according to claim 12, wherein the performing image replacement on the plane rendering region of the effect processing intermediate image based on the object contour image, to obtain a first effect processing image after the image replacement comprises:
determining pixel coordinates of corresponding pixels of the plane rendering region on the effect processing intermediate image;
searching the object contour image for contour pixel information of pixels corresponding to the pixel coordinates;
replacing plane pixel information of pixels in the plane rendering region with the contour pixel information, to construct a contour filling region; and
determining an image comprising the contour filling region as the first effect processing image.

14. The electronic device according to claim 12, wherein the performing color filling on the first effect processing image according to a set color filling strategy, to obtain a second effect processing image after the color filling comprises:
determining a contour background region and an object contour region from a contour filling region of the first effect processing image;
searching the target object original image for object pixel coordinates corresponding to the object contour region, and filling pixel values of the object pixel coordinates into the object contour region;
searching a predetermined effect original rendering image for background pixel coordinates corresponding to the contour background region, and filling pixel values of the background pixel coordinates into the contour background region; and
denoting an image obtained after pixel value filling is performed on the object contour region and the contour background region as the second effect processing image.

15. The electronic device according to claim 9, wherein the method further comprises:
when a reshaping beautification operation on a selected body on the target object is detected, acquiring selected body reshaping information corresponding to the reshaping beautification operation; and
updating the object contour image based on the selected body reshaping information.

16. The electronic device according to claim 15, wherein the updating the object contour image based on the selected body reshaping information comprises:
determining a quantity of times of update cycle of the object contour image based on the selected body reshaping information;
performing pixel value update on all pixels in the object contour image according to a set pixel value update strategy;
forming an updated object contour image based on updated pixel values of all the pixels, and adding 1 to a current update cycle count; and
returning to re-perform the pixel value update until the current update cycle count is equal to the quantity of times of update cycle.

17. A non-transient computer-readable storage medium, comprising computer-executable instructions, wherein the computer-executable instructions, when executed by a processor of a computer, implement a method for effect processing, and the method for effect processing comprises:
in response to a wear trigger operation on an effect wearable item, performing model blocking processing on an effect three-dimensional model of the effect wearable item to obtain an effect blocking three-dimensional model;
acquiring a target object original image currently displayed comprising a target object, and determining an object contour image of the target object original image, wherein a wear body of the effect wearable item is located on the target object; and
based on the effect blocking three-dimensional model in combination with the object contour image, determining and displaying an effect combined image.

18. The storage medium according to claim 17, wherein the performing model blocking processing on an effect three-dimensional model of the effect wearable item to obtain an effect blocking three-dimensional model comprises:
based on model vertex information of the effect three-dimensional model, constructing a two-dimensional blocking plane, and determining a plane placing position that meets a condition from the effect three-dimensional model; and
combining the two-dimensional blocking plane with the effect three-dimensional model at the plane placing position, to obtain the effect blocking three-dimensional model obtained through combination.

19. The storage medium according to claim 18, wherein the based on model vertex information of the effect three-dimensional model, constructing a two-dimensional blocking plane, and determining a plane placing position that meets a condition from the effect three-dimensional model comprises:
based on the model vertex information of the effect three-dimensional model, determining a maximum plane length value and a central axis of a bottom plane formed by bottom vertexes of the effect three-dimensional model;
determining a blocking plane width value based on the maximum plane length value, and constructing the two-dimensional blocking plane in combination with a pre-obtained blocking plane height value; and
determining position information of the central axis as the plane placing position.

20. The storage medium according to claim 17, wherein the based on the effect blocking three-dimensional model in combination with the object contour image, determining and displaying an effect combined image comprises:
performing two-dimensional conversion rendering on the effect blocking three-dimensional model to obtain an effect processing intermediate image, wherein the effect processing intermediate image comprises a plane rendering region of a two-dimensional blocking plane used for effect processing;
performing image replacement on the plane rendering region of the effect processing intermediate image based on the object contour image, to obtain a first effect processing image after the image replacement;
performing color filling on the first effect processing image according to a set color filling strategy, to obtain a second effect processing image after the color filling; and
performing image fusion on the second effect processing image and the target object original image, to obtain and display the effect combined image after fusion.
